(19) United States
(12) Patent Application Publication
(10) Pub. No.: US 2018/0056963 A1
(43) Pub. Date: Mar. 1, 2018

(54) BRAKE-BY-WIRE SYSTEM

(71) Applicant: GM Global Technology Operations LLC, Detroit, MI (US)

(72) Inventors: Eric E. Krueger, Chelsea, MI (US); Alan J. Houtman, Milford, MI (US); Steven J. Weber, Mount Clemens, MI (US)

(21) Appl. No.: 15/252,178

(22) Filed: Aug. 30, 2016

(51) Int. Cl. B60T 13/74

(52) U.S. Cl. CPC B60T 13/741; B60T 2270/402; B60T 2270/82; B60T 2270/414; B60T 2270/404

(57) ABSTRACT

A vehicle is provided. The vehicle includes a plurality of controllers and a driver. Each controller is configured to receive one or more braking signals. Each controller is also configured to generate one or more braking commands in correspondence to the one or more braking signals. The driver is configured to perform a voting operation on the one or more braking commands to determine whether to generate a driving signal to at least one brake.

### FIELD OF THE INVENTION

The invention disclosed herein relates to a vehicle having a brake-by-wire mechanism including a voting protocol for a fault tolerant operation.

### BACKGROUND

Conventional braking systems that provide direct mechanical linkages and/or hydraulic force-transmitting-paths between an operator and brake control units of the vehicle. Conventional braking systems also add a significant weight penalty to the vehicle itself. Thus, reducing or replacing the conventional braking systems is desirable.

Current industrial trends include reducing a number of overall mechanical components and an overall weight of the vehicle through system-by-wire applications, also referred to as X-by-wire systems. One such X-by-wire system is a brake-by-wire system, which sometimes referred to as an electronic braking system (EBS). Present implementations of brake-by-wire systems fail to include electrical redundancy vs mechanical redundancy (e.g., duplication of hardware and/or software to account for component failures), fault tolerance (e.g., overcoming undesired events affecting control signals, data, hardware, software or other elements of such systems), fault monitoring (e.g., detecting undesired events), and other security mechanisms to ensure safe braking.

### SUMMARY OF THE INVENTION

In one exemplary embodiment, a system is provided. The system comprising a plurality of controllers, wherein each controller is configured to receive one or more braking signals and to generate one or more braking commands in correspondence to the one or more braking signals; and a driver configured to perform a voting operation on the one or more braking commands to determine whether to generate a driving signal to at least one brake.

In one exemplary embodiment, a method is provided. The method comprises receiving, by a plurality of processors coupled to a memory, one or more braking signals generated by an emulator; processing, by each of the plurality of processors, the one or more braking signals to determine whether braking is intended; generating, by each of the plurality of processors, one or more braking commands in correspondence to the one or more braking signals when in response to determining that the braking is intended, wherein the one or more braking commands are received by a driver in communication with the plurality of processors and utilizes in a voting operation to determine whether to generate a driving signal to at least one brake.

The above features and advantages are readily apparent from the following detailed description when taken in connection with the accompanying drawings and claims.

### BRIEF DESCRIPTION OF THE DRAWINGS

Other features, advantages and details appear, by way of example only, in the following detailed description of embodiments, the detailed description referring to the drawings in which:

FIG. 1 is a top schematic view of a vehicle having a brake-by-wire system in accordance with an embodiment;

FIG. 2 is a top schematic view of a brake-by-wire system in accordance with an embodiment;

FIG. 3 is a component diagram of a brake-by-wire system in accordance with an embodiment; and

FIG. 4 is a process flow implemented by a brake-by-wire system in accordance with an embodiment.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

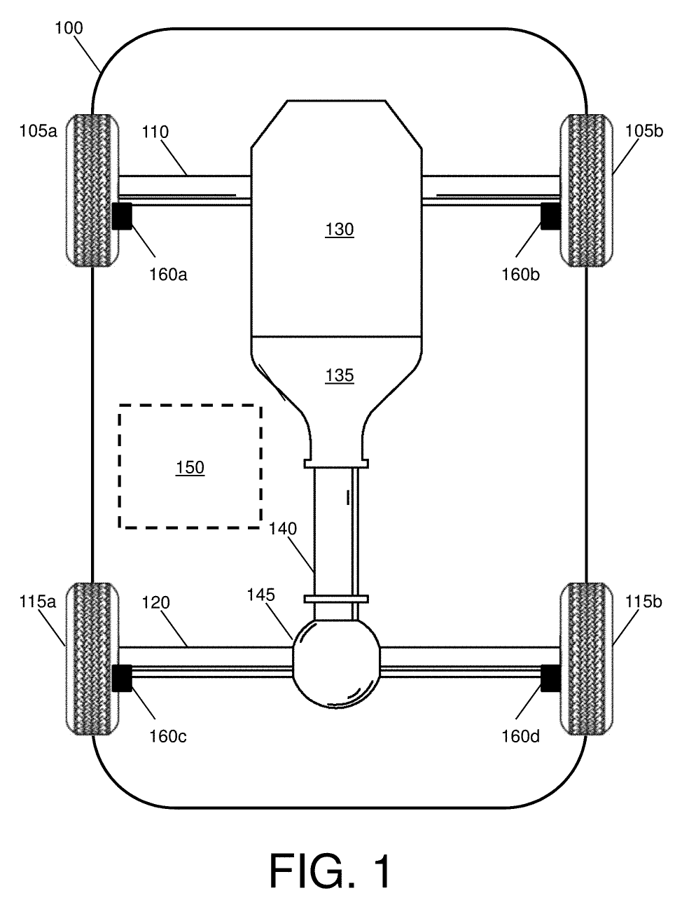

In accordance with an embodiment, FIG. 1 is a top schematic view of a vehicle 100. As illustrated in FIG. 1, the vehicle 100 includes a first wheel pair 105 (e.g., a wheel 105a and a wheel 105b), a first axle 110, a second wheel pair 115 (e.g., a wheel 115a and a wheel 115b), a second axle 120, an engine 130, a transmission 135, a driveshaft 140, a differential assembly 145, a brake-by-wire system 150, and a plurality of brake assemblies 160a-d.

The vehicle 100 may be any automobile, truck, van, sport utility vehicle, or the like. As used herein, the term vehicle is not limited to just an automobile, truck, van, or sport utility vehicle, but may also include any self-propelled or towed conveyance suitable for transporting a burden. Thus, it should be appreciated that the brake-by-wire system 150 described herein may be used with any type of vehicle.

The vehicle 100 may include an engine 130, such as a gasoline or diesel fueled internal combustion engine. The engine 130 may further be a hybrid type engine that combines an internal combustion engine with an electric motor. The engine 130 may also be entirely electric. The engine 130 can be coupled to a frame or other chassis structure of the vehicle 100.

The vehicle 100 may include the first wheel pair 105 arranged adjacent the engine 130 (and connected via a transmission, a driveshaft, a differential assembly, etc., each of which is not shown for simplicity). The engine 130 can also be coupled to the second wheel pair 115 through the transmission 135, the driveshaft 140, and the differential assembly 145. The wheels 105a, 105b, 115a, 115b can be configured to receive outputs from the engine 130 individually, as pairs, or in conjunction with one another.

For example, when the engine 130 is engaged with one or both of the first wheels (105a and 105b), the vehicle 100 may be said to include a front-wheel drive configuration. When the engine 130 is engaged with one or both of the second wheels (115a and 115b), the vehicle 100 may be said to include a rear-wheel drive configuration. When the engine 130 is simultaneously engaged with both the first wheel pair 105 and the second wheel pair 115, the vehicle 100 may be said to include a four-wheel or an all-wheel drive configuration.

The transmission 135 may be configured to reduce a rotational velocity and increase a torque output of the engine 130. In an embodiment, a modified output can then be transmitted to the differential assembly 145 via the driveshaft 140. The differential assembly 145 transmits the output torque from the driveshaft 140 through a differential gear set to the second wheel pair 115 via the second axle 120. The differential gear set is arranged within the differential assembly 145.

The vehicle 100 includes the brake-by-wire system 150 (or sub-system) and at least one of the brake assemblies 160a-d. The brake-by-wire system 150 can be an exclusive-by-wire-system that enables braking torque to the wheels (105a, 105b, 115a, and 115b). Each of the brake assemblies 160a-d can be a device for applying braking torque to the wheels (105a, 105b, 115a, and 115b) to slow or stop a motion of the vehicle 100, such as by contact friction, magnetic operation, etc.

The brake-by-wire system 150 can include one or more components, such as electrical motors, actuators, driver interface devices, emulators, isolators, power electronics, control electronics, modules, drivers, and the brake assemblies 160a-d. The components can be electronically coupled and located throughout the vehicle 100.

For example, the brake-by-wire system 150 can utilize and distribute electrical power from power electronics, such as battery sub-systems of the vehicle 100 or the brake-by-wire system 150 to the components therein. Further, the brake-by-wire system 150 can also include driver interface devices, such as a brake pedal, a parking brake lever, an input button/dial/lever, etc. Each of the driver interface devices can cause the direct application of braking torque (e.g., amount of clamping force) to the wheels (105a, 105b, 115a, and 115b), provide an electrical boost to mechanical and/or hydraulic braking systems, and/or support safe braking when there is no way to generate braking torque from the application of the brake pedal. Thus, the brake-by-wire system 150 can forgo, supplement, assist, or include a mechanical back-up.

In an embodiment, the plurality of brake assemblies 160a-d can be physically and/or electrically connected by electrical conductors (e.g., wires) to the brake-by-wire system 150, and thus can be considered included therein. Each of the plurality of brake assemblies 160a-d can be referred to as a brake corner, a brake assembly, a caliper/rotor assembly, etc. In general, a brake corner can include a caliper, a rotor, an isolator, a driver, and an actuator, where the actuator applies a clamping force from the caliper to the rotor based on a deceleration signal received through the isolator and the driver. Thus, each of the plurality of brake assemblies 160a-d can be configured to selectively slow the rotation of an associated wheel (105a, 105b, 115a, or 115b).

Each of the plurality of brake assemblies 160a-d can be configured to respond, whether independently or in concert, to a deceleration action from the brake-by-wire system 150. For instance, by applying braking torque to a brake pedal, activating a parking brake, operating an input button or lever, etc., an operator of a vehicle causes a deceleration signal to be sent from the brake-by-wire system 150 to the plurality of brake assemblies 160a-d.

With respect to the brake pedal, force and travel sensors can be coupled to the brake pedal to detect elements of a clamping force and/or calculate an amount of the clamping force. The clamping force can be translated by the brake-by-wire system 150 into the deceleration signal. A sensor is any converter that measures physical quantities and converts these physical quantities into a signal (e.g., raw sensor data, such as voltage in analog form; also referred to as analog sensor data). Thus, a sensor can be any device configured to detect status/condition information of mechanical machinery of the vehicle 100 of FIG. 1 and/or control electronics of the vehicle 100 of FIG. 1 and produce the analog sensor data. Examples of sensors include, but are not limited to, strain gauges that measure the physical stress or force applied (e.g., fiber optic gauges, foil gauges, capacitive gauges, etc.); travel sensors that measure movement (e.g., accelerometers, gyroscopes, etc.); and temperature sensors that measure the temperature characteristics and/or the physical change in temperature (e.g., fiber optic temperature sensors, heat meters, infrared thermometers, liquid crystal thermometers, resistance thermometers, temperature strips, thermistors, thermocouples, etc.).

With respect to the parking brake, a travel sensor can be coupled to the parking brake to detect an on-position that is translated by the brake-by-wire system 150, which in this case can indicate a predetermined clamping force that provides a full stop. The input button/dial/lever can also operate to receive an input from the operator to enable the brake-by-wire system 150 to generate, as the deceleration signal, a predetermined and/or variable clamping force. The deceleration signal causes the plurality of brake assemblies 160a-d, whether individually or in concert, to apply a braking torque on corresponding wheels that result in wheel rotational deceleration.

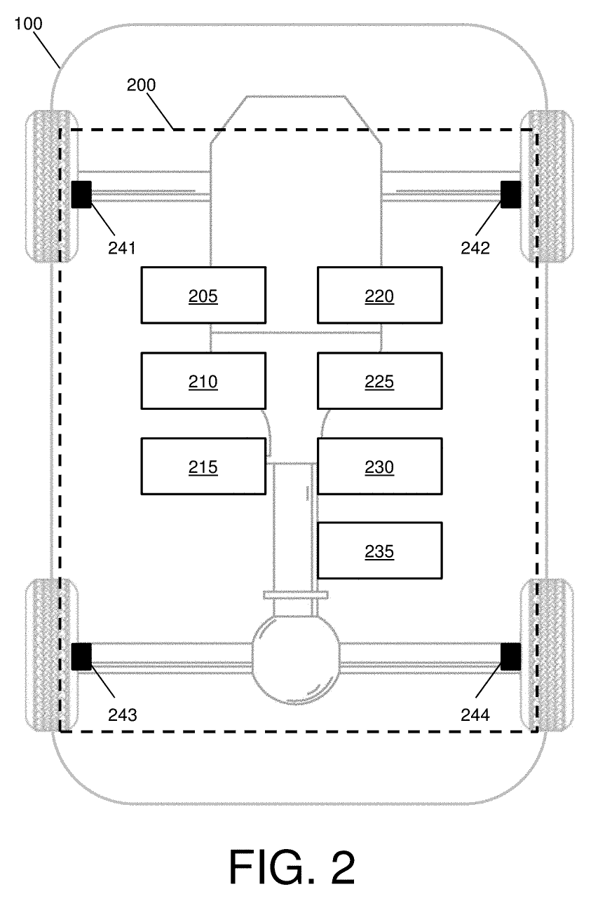

The brake-by-wire system 150 will now be described according to an embodiment and with reference to FIG. 2. As illustrated, the brake-by-wire system 150 can be embodied as a system 200. The system 200 can include a controller 205, an actuator 210, a driver interface device 215, an isolator 220, a driver 225, power electronics 230, a module 235, a first brake 241, a second brake 242, a third brake 243, and a fourth brake 244. The components of the system 200 can be electronically coupled and located throughout the vehicle 100 of FIG. 1, along with being configured to communicate/interact with each other. While single items are illustrated by FIG. 2 for each component of the system 200, these representations are not intended to be limiting and thus, the each component may represent a plurality of that component. It should be appreciated that the system 200 can include other components used in the operation of the vehicle 100 of FIG. 1, that the system 200 may also include fewer modules, that the components can be embodied in separate arrangements in a distributed manner, and that the components can be an integrated control scheme.

The system 200 can be referred to as a control system of the brake-by-wire system 150. The system 200 can, via input/output (I/O) interfaces, receive inputs, such as operator input from the driver interface device 215 and environmental inputs from sensors of the vehicle 100 of FIG. 1. The I/O interfaces can include any physical and/or virtual mechanisms utilized by the system 200 to communicate between components internal and/or external to the system 200 (e.g., the I/O interfaces can be configured to receive or send signals or data within or for the system 200). The inputs are processed by the controller 205.

The controller 205 can generate commands and/or currents to drive the actuator 210. In general, the controller 205 receives a signal from the driver interface device 215, processes the signal, and generates a command to the driver 225 based on the processed signal (e.g., the driver in turn communicates with the actuator 210, which operates one or more of the brakes 241-244). In another embodiment, the sensors detect travel/force/etc. imparted by an operator of the vehicle 100 of FIG. 1 when commanding deceleration. The travel/force/etc. signals are used to determine an amount of deceleration (e.g., a clamping force). The driver 225 communicates the amount of deceleration with the driver interface device 215, which is further communicated to the actuators 210 and actually applied to the brakes 241-244 at the wheels.

The controller 205 includes any processing hardware, software, or combination of hardware and software utilized by the system 200 that carries out computer readable program instructions by performing arithmetical, logical, and/or input/output operations. The controller 205 can include a memory (e.g., a tangible device) configured to store software and/or computer readable program instructions. Examples of the controller 205 include, but are not limited to, an arithmetic logic unit, which performs arithmetic and logical operations; a control unit, which extracts, decodes, and executes instructions from a memory; and an array unit, which utilizes multiple parallel computing elements. Other examples of the controller include an electronic control module/unit/controller, electronic parking brake module, and an application specific integrated circuit. In an embodiment, the system 200 can include two or more controllers 205 to meet requirements of power assist failures, such that if a first controller fails then a second or subsequent controller 205 continues operation.

The actuator 210 can be any type of motor that converts energy into motion, thereby controlling the movement of a mechanism, such as the brakes 241-244, based on received signals. Thus, the actuator 210 can be a direct current motor configured to generate electro-hydraulic braking torque to the corner (e.g., the brake corner, the brake assembly, the caliper/rotor assembly, etc.). The driver interface device 215 can be any combination of hardware and software that enables a component of the system 200 to behave like a component not included in, or replaced by, the system 200. For example, the driver interface device 215 can be a pedal emulator that behaves like a mechanical pedal of a hydraulic braking system. The isolator 220 can be device that transmits signals (e.g., microwave or radio frequency power) in one direction only and shields components on an input side, from the effects of conditions on an output side.

The driver 225 can be a device that transmits signals based on commands of the controller 205 to the actuator 210. The driver 225, like the controller 205, can include any processing hardware, software, or combination of hardware and software utilized by the system 200 that carries out computer readable program instructions by performing arithmetical, logical, and/or input/output operations. The driver 225 can include a memory (e.g., a tangible device) configured to store software and/or computer readable program instructions.

The power electronics 230 can control and manage electrical power throughout the system 200 and vehicle 100 of FIG. 1. The power electronics 230 can include, but are not limited to, batteries, fuses, semi-conductor based devices that are able to switch quantities of power, rectification devices, AC-to-DC conversion devices, and DC-to-AC conversion devices. The power electronics 230 can include or be in communication with first and secondary power sources to operate the system 200. For example, the first power source can be a primary 12 volt system that provides all power to run engine 130 of FIG. 1 etc., and the secondary power source can be a battery that powers the vehicle 100 of FIG. 1 when the primary power source fails.

The module 235 can include any processing hardware, software, or combination of hardware and software utilized by the system 200 to receive and respond to signals within the system. The module 235 can be embodied within the controller 205 as hardware and/or computer readable program instructions stored on a memory of the controller. Thus, in an embodiment, the controller 205 can be referred to as an electronic brake controller that includes a plurality of modules 235 (e.g., sub-components), such as an electronic parking brake module and a brake assist module.

In an embodiment, the electronic parking brake module transmits a signal to a plurality of actuators 210 causing brake calipers of the brakes 241-244 to clamp rotors with the desired amount of clamping force. This transmitted signal can include a clamping force, which in this case can indicate a predetermined clamping force that provides a full stop.

The brake assist module can determine parameters associated with deceleration actions and determine if assistance should be provided to aid braking and how much assistance is to be applied. The brake assist module can send a signal to an engine control module to request that an engine reduce the power output, which will aid in decelerating the vehicle 100.

The brake assist module further monitors the operation of the vehicle 100 of FIG. 1, such as via the brake apply sensors (e.g., brake pedal travel and brake pedal force) and the wheel speed sensors. In the event that the brake assist module determines, such as via sensors that indicate the vehicle 100 of FIG. 1, the brake-by-wire system 150, or the system 200 of FIG. 2 is not operating at a desired performance level, a signal may be transmitted to the electronic parking brake module.

The brakes 241-244 are devices for slowing or stopping motion of the vehicle 100 of FIG. 1. Each of the brakes 241-244 can be referred to as a brake assembly, brake corner, brake assembly, a caliper/rotor assembly, etc. Each of the brakes 241-244 can be configured to respond, whether directly or in concert, to a deceleration action from the emulator 215 and/or controller 205.

In an embodiment, an application of the brake-by-wire system 150 can be adjusted based on the operational characteristics of the vehicle 100. For example, when the vehicle 100 of FIG. 1 is traveling at a slower speed the controller 205 can operate the actuator 210 to apply an increased amount of clamping force to a corresponding one of the brakes 241-244 at a slower rate than at a faster rate required when the vehicle 100 is travelling at a higher speed. Further, the controller 205 can monitor the wheels, determine if there is any wheel lockup, and adjust the amount of clamping force on any one of the brakes 241-244 to alleviate or prevent the lockup from occurring.

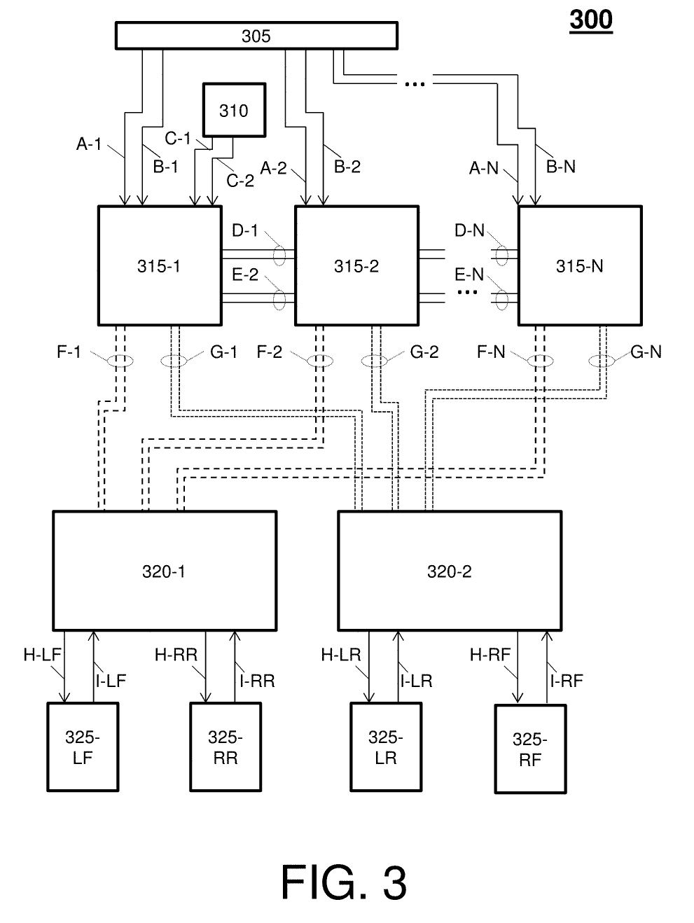

Turning now to FIG. 3, the brake-by-wire system 150 and the system 200 will now be described with reference to a system 300 according to an embodiment. As illustrated, the system 300 can include a pedal assembly 305, an electronic parking brake actuator 310, an electric control unit 315, a driver 320, and a brake 325.

The items illustrated by FIG. 3 are representations and are not intended to be limiting. Each component may represent a plurality of that component and/or each plurality may represent a singular iteration thereof. It should also be appreciated that the system 300 can include other components, that the system 300 can include fewer components, that the components can be embodied in separate arrangements in a distributed manner, and that the components can be embodied in an integrated control scheme.

For example, the electric control unit 315 is illustrated as a plurality of electric control units notated by the electric control unit 315-1, the electric control unit 315-2, and the electric control unit 315-N, wherein N is a whole number. The driver 320 is illustrated as a plurality of drivers notated by the driver 320-1 and the driver 320-2. The brake 325 is illustrated as a plurality of brakes notated by the brake 325-LF, the brake 325-RR, the brake 325-LR, and the brake 325-RF, where each brake of the plurality is aligned with a wheel (of a vehicle 100). Note that the notation LF indicates left-front, the notation RR indicates right-rear, the notation LR indicates left-rear, and the notation RF indicates right-front. Thus, in the embodiment of FIG. 3, the system 300 includes a first driver 320-1 that controls braking at the brakes 325-LF and 325-RR and a second driver 320-2a that controls braking at the brakes 325-LR and 325-RF.

The components of the system 300 can be electronically coupled and located throughout the vehicle 100 of FIGS. 1-2, along with being configured to communicate/interact with each other. As shown in FIG. 3, signals are identified by various arrows and lines. These signals represent communications between the pedal assembly 305 and the electric control units 315, as indicated by the signals A-1, A-2, A-N, B-1, B-2, and B-N (where N is a whole number); communications between the electronic parking brake actuator 310 and the electric control units 315, as indicated by the signals C-1 and C-2; communications between the electric control units 315, as indicated by the signals D-1 and D-N (where N is a whole number); communications between the electric control units 315 and the drivers 320, as indicated by the signals F-1, F-2, F-N, G-1, G-2, and G-N (wherein N is a whole number); and communications between the drivers 320 and brakes 225, as indicated by the signals H-LF, H-RR, H-LR, H-RF, I-LF, I-RR, I-LR, and I-RF.

In general, the system 300 provides a safe braking scheme through a robust implementation of multiple redundant components and/or algorithms that receive inputs from multiple sensors. The safe braking scheme by the system 300 embodies a fault tolerant braking architecture in which multiple voting algorithms determine a braking intent of the driver. The fault tolerant braking architecture guarantees that no single detected or undetected (assumed) fault can prevent a desired brake apply or cause a false brake apply. An assumed fault can include when a sensor fails within a range (e.g., the sensor outputs looks and appears valid, such as when analog outputs form two sensors are offset and cross).

The pedal assembly 305 can be an emulator 215 as described above. Further, the pedal assembly 305 can be an electro-mechanical device that mimics a typical mechanical pedal of a hydraulic braking system. The pedal assembly 305 can mimic the mechanical pedal by including a lever coupled to a force sensor and a travel sensor. The force sensor determines an amount of energy applied to the lever. The travel sensor determines a distance moved by the lever. The pedal assembly 305 outputs at least one braking signal, such as the amount of force as detected by the force sensor and/or the distance moved as detected by the travel sensor as braking signals A and B, respectively, to the electric control units 315. In an embodiment, the pedal assembly 305 outputs a pair of braking signals A and B to each electric control unit 315. For example, as shown in FIG. 3, the pedal assembly 305 outputs N number of signal pairs to N number of electric control unit 315 (e.g., a braking signal pair A-1 and B-1 to the electric control unit 315-1, a braking signal pair A-2 and B-2 to the electric control unit 315-2, etc.).

The electronic parking brake actuator 310 can be an emulator 215, as described above. Further, the electronic parking brake actuator 310 can be an electro-mechanical device that mimics a mechanical lever of a cable or hydraulic braking system. The electronic parking brake actuator 310 can mimic the mechanical lever by including a lever coupled to a position sensor that determines a location of the mechanical level. The electronic parking brake actuator 310 outputs an electronic brake position, as signal C, based on the location of the mechanical level. For example, as shown in FIG. 3, when the location of the mechanical level is in a first position, the electronic brake position can be off and a signal C-1 can be communicated to the electric control unit 315-1. Further, when the location of the mechanical level is in a second position, the electronic brake position can be on and a signal C-2 can be communicated to the electric control unit 315-1.

The electric control unit 315 can be a controller 205, as described above. In general, the electric control unit 315 can include any processing hardware, software, or combination of hardware and software utilized by the system 300 that implement architectures to achieve a safety level for the system 300. Note the one electric control unit 315 can be integrated into other controllers (e.g., of the vehicle 100), to reduce costs of additional hardware and/or software.

The electric control unit 315 can receive a plurality of inputs, which include inputs from the pedal assembly 305, inputs from the electronic parking brake actuator 310, and/or external braking requests from safety system (e.g., an Adaptive Cruise Control and Collision Imminent Braking). For example, the electric control unit 315-1 can receive signals A-1, B-1, C-1, and C-2; the electric control unit 315-2 can receive signals A-2 and B-2; and the electric control unit 315-N can receive signals A-N and B-N. Further, the plurality of inputs can include engine revolutions per minute, vehicle speed, ambient temperature (e.g., in and/or outside of the vehicle), wheel sensor, inertial measurement unit, etc.

The plurality of inputs can be used by the electric control unit 315 to generate commands and/or currents that drive the driver 320. The commands and/or currents can be responsive to one or more of the plurality of inputs. The commands and/or currents are, in turn, braking commands by the electric control unit 315 to the driver 320 based on the operation of the pedal assembly 305.

For instance, by applying pressure to a brake pedal of the pedal assembly 305, an operator causes signals A and B (e.g., the amount of force as detected by the force sensor and the distance moved as detected by the travel sensor) to be sent to the electric control unit 315. The electric control unit 315 can process the amount of force and the distance moved to detect that a brake signal is intended by the operator. To detect a brake signal, the electric control unit 315 determines whether the amount of force and/or the distance moved are greater than a threshold or slope. If the brake signal is detected, the electric control unit 315 can generate at least one braking command to the driver 320. Each braking command, in general, can correspond to a particular brake 325. In an embodiment where a vehicle includes a single brake, a braking command can be generated by each electric control unit 315 to a driver 320 associated with the single brake.

The commands and/or currents can also be braking commands by the electric control unit 315 to the driver 320 based on the operation of the electronic parking brake actuator 310. In an embodiment, when the electric control unit 315-1 detects an activation of the parking brake based on signals C-1 and C-2, the electric control unit 315-1 can communicate across a controller area network with the other electric control units 315 to provide the corresponding braking commands to all brakes 325. The controller area network is a bus that allows microcontrollers and devices to communicate with each other. Thus, the electric control units 315 can also communicate amongst each other such through the controller area network represented by signals D-1, E-1, D-N, and E-N.

In an embodiment, as shown in FIG. 3, the signals A-1 and B-1 can be used by the electric control unit 315-1 to generate the braking command pair F-1, where one dashed-line corresponds to a left front brake 325-LF and the other dashed-line corresponds to a right rear brake 325-RR; the signals A-2 and B-2 can be used by the electric control unit 315-2 to generate the braking command pair F-2, where one dashed-line corresponds to a left front brake 325-LF and the other dashed-line corresponds to a right rear brake 325-RR; etc. Further, the signals A-1 and B-1 can be used by the electric control unit 315-1 to generate the braking command pair G-1, where one dotted-line corresponds to a left rear brake 325-LF and the other dotted-line corresponds to a right front brake 325-RR; the signals A-2 and B-2 can be used by the electric control unit 315-2 to generate the braking command pair G-2, where one dotted-line corresponds to a left rear brake 325-LF and the other dotted-line corresponds to a right front brake 325-RR; etc. In this way, the system 300 includes redundant communication between the pedal assembly 205, the electric control unit 315, and the driver 320.

The driver 320 can be a driver 225, as described above. In general, the driver 320 can use inputs from the electric control unit 315 to enable safe braking by outputting units of force to the brake 325, such as by a high current between an actuator of the brake 325 and driver 320 (e.g., power and signal) or by serial data signal (e.g., with power being separate). Further, the driver 320 can include any processing hardware, software, or combination of hardware and software utilized by the system 300 to implement voting algorithms. The voting algorithms tally the braking commands from each of the electric control units 315 and determine braking activity (e.g., use inputs from the electric control units 315 in a control suite to enable safe braking). The voting algorithms can be executed continuously to ensure that no single assumed failure and/or multiple detectable failures (depending on the actual scheme) result in a false brake apply or a false brake non-apply. The voting algorithms can include one or more voting schemes, examples of which include a one-out-of-two scheme, a two-out-of-three scheme, a two-out-of-four scheme, a three-out-of-four scheme, etc. Note that a one-out-of-two scheme does not allow robustness against the unwanted prevention of a desired apply.

In the one-out-of-two scheme embodiment, the control suite must detect at least one positive brake signal from two braking commands to drive the brakes 325. In the two-out-of-three scheme embodiment, the control suite uses three braking commands, where two of these commands must be positive brake signals to drive the brakes 325. In this way, the voting algorithm can provide fault tolerance for any detected or assumed failure(s) based on a single voting algorithm or a combination of voting algorithms.

The drivers 320 can be standalone motor drivers, motor driver modules integrated into corner actuators (e.g., corner assemblies), or up-integrated into the electric control units 315. The voting algorithms can also be up-integrated into the electric control units 315, integrated into standalone controllers, or embodied a combination of standalone and existing controllers.

The brakes 325 are an example of brakes 160a-d, as described above. Further, the brakes 325 can act individually or in concert based on the driving commands, such as signals H-LF, H-RR, H-LR, and H-RF, to apply a pressure on corresponding wheels that result in wheel rotational deceleration. The brakes 325 can also return feedback communications, such as signals I-LF, I-RR, I-LR, and I-RF, to the drivers 320 that indicate the wheel speed, brake operability, etc.

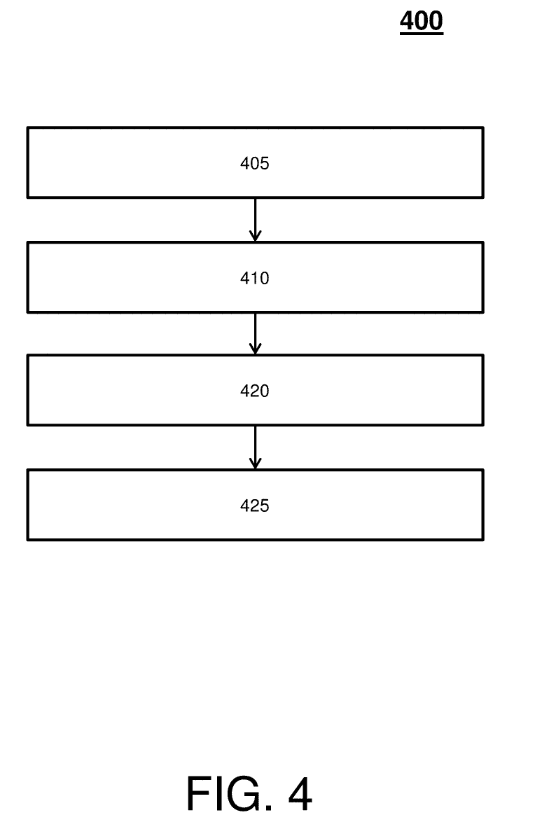

An operation of the system 300 will now be described with respect to FIG. 4 and process flow 400. The process flow begins at block 405, where travel and force pedal inputs are generated. The travel and force pedal inputs can be generated by the pedal assembly 305 and received by the plurality of controllers 315.

Each of the plurality of controllers 315 can independently process the travel and force pedal inputs to determine if braking is intended by a vehicle operator. Each of the plurality of controllers can also independently process the travel and force pedal inputs to determine a degree of intended braking. For instance, when the travel and force pedal inputs are gradual (e.g., have a limited slope), the intent may be a gentle braking of the vehicle. When the travel and force pedal inputs are sharp (e.g., have an exponential slope), the intent may be an immediate braking of the vehicle.

At block 410, brake commands are generated based on travel and force pedal inputs. The brake commands can be generated by the plurality of controllers 315. Each brake command generated by an independent controller 315 can correspond to an individual brake 325, such that if four brakes exist on a vehicle then each independent controller 315 generates four brake commands for each of those brakes. These brake commands are sent to at least one driver 320. As shown in FIG. 3, two drivers 320-1 and 320-2 are employed. Further, all brake commands can be sent to a single driver 320 that controls all brakes 325 or more that two drivers 320 based on the configuration of the system 300.

At block 420, a voting operation is performed on the brake commands. The voting operation can be performed by the driver 320. The driver 320 can utilize the voting operation to generate driving commands.

At block 425, braking is performed based on the driving commands. The braking can be performed by the brakes in direct correspondence to the driving commands from the driver 320.

Embodiments herein provide advantages in lowering the amount of effort required by the driver to stop a vehicle, improved response time, more flexible packaging, fault tolerance, pedal feel consistency, etc. Further advantages are provided in a voting scheme that ensures that a single undetectable failure of a sensor or controller does not result in a false action by the brake system and improved brake assist availability by preventing any single failure or latent failure from causing a loss of brake assist. For instance, when more than three voting controllers are implemented, two detected failures, or one detected and one assumed failure can be withstood while continuing to provide brake assist.

Aspects of embodiments herein are described with reference to flowchart illustrations and/or block diagrams of methods, apparatus (systems), and computer program products according to embodiments \. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the operations/acts specified in the flowchart and/or block diagram block or blocks. These computer readable program instructions may also be stored in a computer readable storage medium that can direct a computer, a programmable data processing apparatus, and/or other devices to operate in a particular manner, such that the computer readable storage medium having instructions stored therein comprises an article of manufacture including instructions which implement aspects of the operation/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the operations/acts specified in the flowchart and/or block diagram block or blocks.

The flowchart and block diagrams in the FIGS. illustrate the architecture, operability, and operation of possible implementations of systems, methods, and computer program products according to various embodiments. In this regard, each block in the flowchart or block diagrams may represent a module, segment, or portion of instructions, which comprises one or more executable instructions for implementing the specified logical operation(s). In some alternative implementations, the operations noted in the block may occur out of the order noted in the FIGS. For example, two blocks shown in succession may, in fact, be executed substantially concurrently, or the blocks may sometimes be executed in the reverse order, depending upon the operability involved. It will also be noted that each block of the block diagrams and/or flowchart illustration, and combinations of blocks in the block diagrams and/or flowchart illustration, can be implemented by special purpose hardware-based systems that perform the specified operations or acts or carry out combinations of special purpose hardware and computer instructions.

The flow diagrams depicted herein are just one example. There may be many variations to this diagram or the steps (or operations) described therein without departing from the spirit of the disclosed. For instance, the steps may be performed in a differing order or steps may be added, deleted or modified. All of these variations are considered a part of the claims.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A system comprising:
a plurality of controllers,
wherein each controller is configured to receive one or more braking signals and to generate one or more braking commands in correspondence to the one or more braking signals; and
a driver configured to perform a voting operation on the one or more braking commands to determine whether to generate a driving signal to at least one brake.

2. The system of claim 1, wherein the one or more braking signals include a force signal or a travel signal generated by an emulator.

3. The system of claim 2, wherein each controller is configured to process the force signal or the travel signal to determine whether braking is intended.

4. The system of claim 1, wherein the voting operation detects a number of positive commands of the one or more braking commands to determine whether to generate the driving signal to the at least one brake.

5. The system of claim 4, wherein the voting operation is a two-by scheme that generates the driving signal when the number of positive commands is at least two.

6. The system of claim 4, wherein the voting operation is a three-by scheme that generates the driving signal when the number of positive commands is at least three. The system of claim 1, comprising:
a plurality of drivers,
wherein each driver is configured to independently receive the one or more braking commands from each of the plurality of controllers,
wherein the plurality of drivers comprises the driver.

8. The system of claim 7, wherein each driver is configured to independently control a corresponding one of the at least one brake based on the one or more braking commands.

9. The system of claim 1, wherein the driver is configured to send the driving signal to a plurality of brakes based on the one or more braking commands from each of the plurality of controllers, wherein the plurality of brakes comprises the at least one brake.

10. The system of claim 1, comprising:
a plurality of brakes,
wherein each brake is configured to independently apply a clamping force in response to the driving signal from the driver, and
wherein the plurality of brakes comprises the at least one brake.

11. The system of claim 1, wherein the driver and the plurality of controllers are integrated into a circuit.

12. The system of claim 1, wherein the system is a brake-by-wire system employed in a vehicle.

13. A method comprising:
receiving, by a plurality of processors coupled to a memory, one or more braking signals generated by an emulator;
processing, by each of the plurality of processors, the one or more braking signals to determine whether braking is intended;
generating, by each of the plurality of processors, one or more braking commands in correspondence to the one or more braking signals when in response to determining that the braking is intended,
wherein the one or more braking commands are received by a driver in communication with the plurality of processors and utilizes in a voting operation to determine whether to generate a driving signal to at least one brake.

14. The method of claim 13, wherein the one or more braking signals include a force signal or a travel signal.

15. The method of claim 14, comprising:
processing the force signal or the travel signal to determine whether braking is intended.

16. The method of claim 13, wherein the voting operation detects a number of positive commands of the one or more braking commands to determine whether to generate the driving signal to the at least one brake.

17. The method of claim 16, wherein the voting operation is a two-by scheme that generates the driving signal when the number of positive commands is at least two.

18. The method of claim 16, wherein the voting operation is a three-by scheme that generates the driving signal when the number of positive commands is at least three.

19. The method of claim 13, wherein the driver and the plurality of processors are integrated into a circuit.

20. The method of claim 13, wherein a brake-by-wire system employed in a vehicle that comprises the plurality of processors.
